(19) United States
(12) Patent Application Publication
(10) Pub. No.: US 2007/0267551 A1
(43) Pub. Date: Nov. 22, 2007

(54) IV Pole Caddy

(76) Inventor: Joseph Gordon Townsend, Gutenberg, NJ (US)

Correspondence Address: LAW OFFICES OF DONALD COX, P.O. BOX 505, PRINCETON, NJ, 08542-0505, US

(21) Appl. No.: 11/751,630

(22) Filed: May 21, 2007

Related U.S. Application Data
(60) Provisional application No. 60/801,470, filed on May 19, 2006.

(51) Int. Cl. F16M 11/00; A47K 1/08

(52) U.S. Cl. 248/125.8; 248/311.2; 248/230.6

(57) ABSTRACT

An IV pole assembly includes an IV pole having a vertically oriented center rod, hooks for supporting an intravenous bag and a support base and a caddy having a plurality of compartments having at least one compartment sized and shaped to hold a magazine and at least one compartment sized and shaped to hold an item selected from the group consisting of eyewear, a beverage bottle, a personal electronic communications device and a personal listening device. An engagement is included for holding the caddy at a generally fixed position along the vertical length of the pole; wherein attaching the caddy to the pole results in a storage area for holding a patients personal items that moves with the IV pole.

### CROSS-REFERENCE TO RELATED APPLICATIONS

This application claims the benefit of U.S. Provisional Application No. 60/801,470 filed May 19, 2006, which is incorporated herein by reference.

### BACKGROUND OF THE INVENTION

1. Field of the Invention

This invention relates generally to IV pole accessories, and, more particularly, to IV pole attachments to improve the utility of the pole to personal needs of the patient.

2. Description of the Related Art

In the health care industry, intra-venous (IV) poles have become commonplace tools in any health care facility. Although originally intended as a solution for suspending fluids and medications for intra-venous delivery to a patient, the utility of these poles have been adapted to support a variety of medical care equipment, including, but not limited to, automated IV delivery systems, monitoring equipment, oxygen tanks and other medical related equipment that is often tailored to the patient's medical needs. IV poles themselves are intended to be suspended above the patient and can be supported by a moveable or wheeled base on the floor or from mounting posts located on a hospital bed or wheelchair.

These devices are easily adapted for mobility and a releasable upper portion of the pole can easily be moved from a post support on a bed to a post support on a wheelchair to a free standing mobile base. In this way the supporting equipment necessary to the medical care of the patient is always at hand.

One drawback is that often the patient's own needs are not attended to by such mobility. The ability to move quickly from one place to another often means that the personal affects of the patient are left with the last place the patient was located either near the hospital bed or associated with a wheelchair. Personal affects such as eyewear or other personal item can be lost. Often the patient's demeanor and well being can be affected by long waits at various locations wait for a X-Ray or Cat-Scan. The patient would be in a much better position to spend the time if their personal affects had traveled with them.

Medical personnel are often focused on the medical needs of the patient and often the personal needs may be overlooked. Thus, the need exists for a way for patients to bring along their personal affects without the need for medical personnel to get distracted from attending the patient's medical needs.

### SUMMARY OF THE INVENTION

An IV pole assembly includes an IV pole having a vertically oriented center rod, hooks for supporting an intravenous bag and a support base and a caddy having a plurality of compartments having at least one compartment sized and shaped to hold a magazine and at least one compartment sized and shaped to hold an item selected from the group consisting of eyewear, a beverage bottle, a personal electronic communications device and a personal listening device. An engagement is included for holding the caddy at a generally fixed position along the vertical length of the pole; wherein attaching the caddy to the pole results in a storage area for holding a patients personal items that moves with the IV pole.

In one embodiment, the engagement is a clamp clamped onto the pole and a bar extend between the caddy and clamp in spaced apart relation.

In another embodiment, the IV pole includes a handle clamp and the engagement includes a clamp arrangement for clamping to the handle clamp and suspending the caddy there from.

In another embodiment, the caddy includes a support member for suspend the caddy from auxiliary equipment coupled to the IV pole.

In yet another embodiment, the caddy includes a strap assembly for holding the caddy to the IV pole by strapping it onto the auxiliary equipment.

In another embodiment, the caddy is in the form of fabric compartments and includes straps that connect for hanging from an IV pole.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is a partially exploded perspective view of an Intra-venous (IV) pole with an IV pole caddy and an eyewear holder according to the present invention;

FIG. 2 is a side view of an alternate embodiment of an IV pole caddy according to the present invention;

FIG. 3 is a side view of an alternate embodiment of an IV pole caddy according to the present invention;

FIG. 4 is a side view of an alternate embodiment of an IV pole caddy according to the present invention;

FIG. 5 is a front perspective view of an alternate embodiment of an IV pole caddy according to the present invention;

FIG. 6 is a rear perspective view of the IV pole caddy of FIG. 5;

FIG. 7 is a perspective view of a clamp for an IV pole caddy according to the present invention;

FIG. 8 is a perspective view of a clamp for an IV pole caddy according to the present invention;

FIG. 9A is a perspective view of an alternative IV pole caddy according to the present invention;

FIG. 9B is a backside view of the IV pole caddy of FIG. 9A; and

FIG. 9C is a perspective view of a clamp for an IV pole caddy according to the present invention.

### DETAILED DESCRIPTION

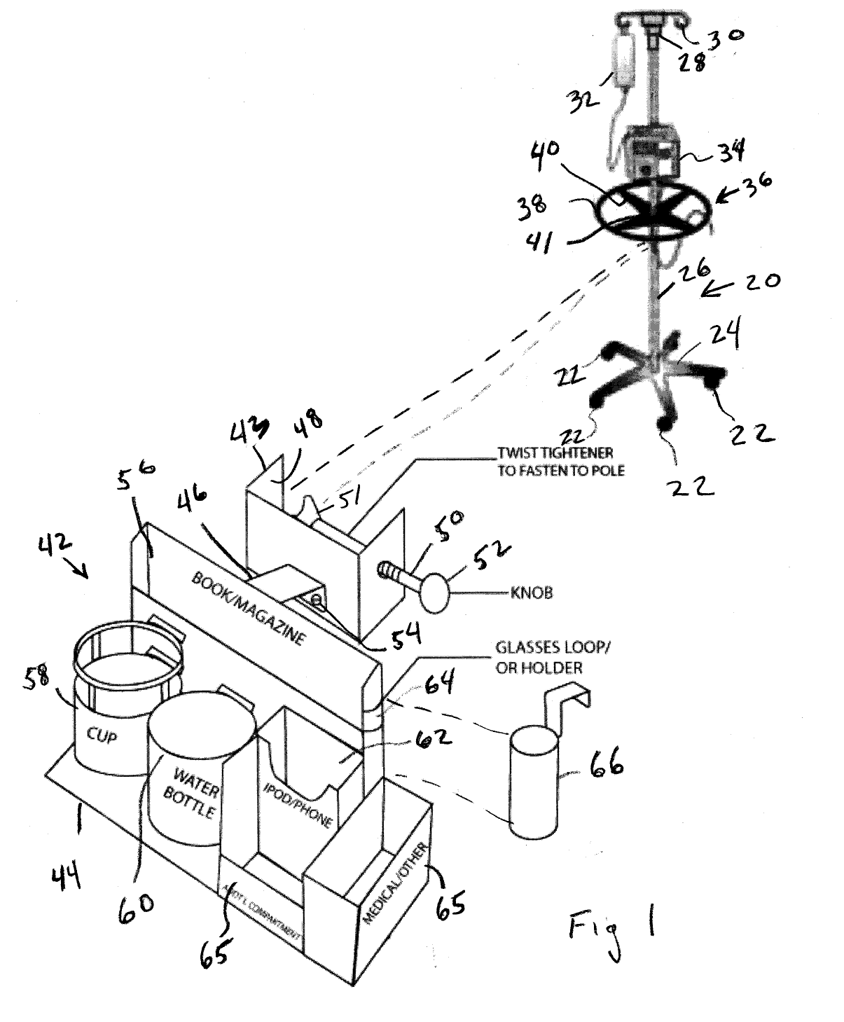

With reference to FIG. 1 for purposes of illustration, a free standing IV pole 20 having a coaster wheels 22 attached to a base 24, a vertical pole 26 terminating at an upper end 28 with hooks 30 for holding IV bags 32 also includes a representative piece of auxiliary equipment 34 in the form of an IV pump and includes a handle 36 for pushing the pole in the form of a cylindrical bar 38 bent into a circle having a radius at the longitudinal center of the pole and supported by plurality of radiating spokes 40 that connect about a clamp 41 that in turn connects to the pole. Advantageously, a patient caddy 42 having attachment means in the form of a pole clamp 43 is configured for attachment to the IV pole 20. The caddy includes a compartment housing 44 suspended by a support bar 46 for connection to the clamp 43. The clamp 43 is preferably configured with a pole support 48 and threaded screw 50 for securely holding the pole between the pole support and the screw base 51. A knob 52 allows for easy manual attachment and release of the clamp from the pole. A clamp of the type suitable for this purpose is sold by Pryor Products of Oceanside, Calif. under the name Standard C-Clamp (cat. #283). Secured by screws 54, the reinforced bar 46 extends from the clamp 43 and attaches, or is formed integrally with, the compartment housing 44. The compartment housing includes a plurality of compartments that include, but are not limited to, a book or magazine holder 56, a cup holder 58 and water bottle holder 60, a holder for electronic devices 62 such as, but not limited to, an MP3 player or cellular telephone, medine and other holders 65, as well as an elastic loop material or molded plastic ring 64 for holding eyewear or an eyeglass holder 66.

The caddy compartments may be built to medical facility specifications and may include embodiments constructed from metal such as folded sheet metal and injection molded plastic such as polypropylene. Presently, injection molded plastic is preferred, however, factors such as intended load of the caddy, fire regulations and cost considerations may result in other desired manufacturing configurations.

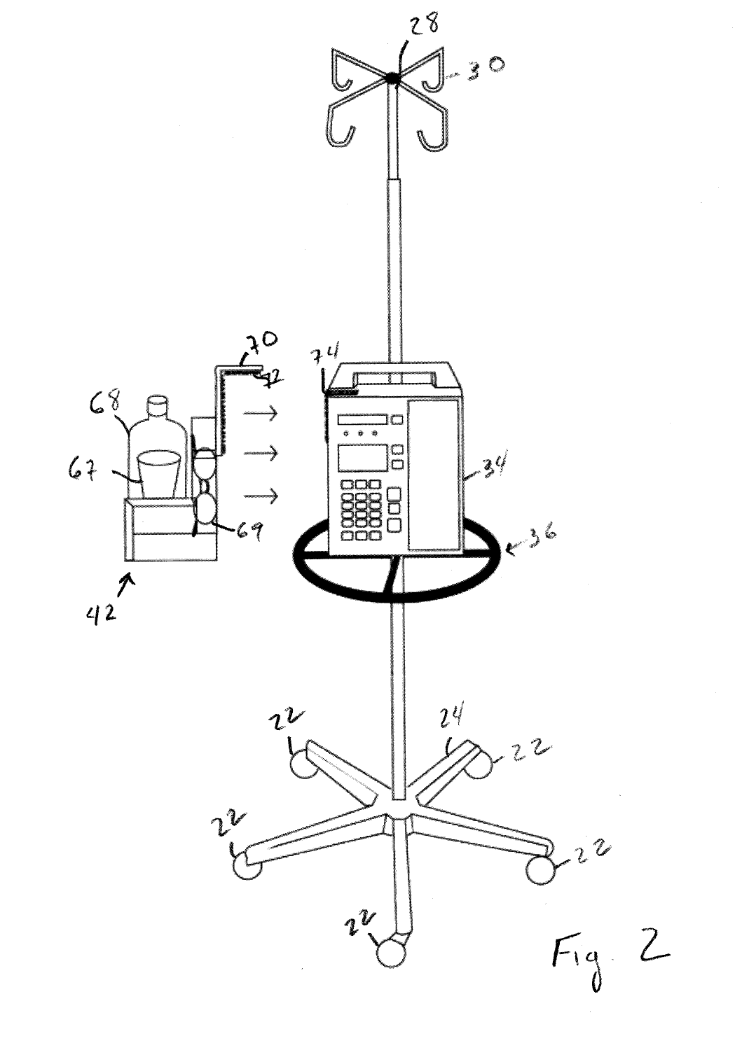

With reference to FIG. 2, an alternate embodiment of an IV pole caddy 42 includes a plurality of compartments similar to FIG. 1 and shown with cup 67, bottle 68 and eyewear 69. An L-shaped engagement member 70 extends up and away from the plurality of compartments for attachment to auxiliary equipment on the IV pole. An adhesive bonding tape or opposing sides of hook and loop material 72 and 74 may be used to attach the L-shaped member 70 to the auxiliary equipment 34. The IV pole caddy 42 then maintains a relative position on the IV pole via attachment to the auxiliary equipment 34. The L-shaped member 70 may be formed integrally with the plurality of caddy compartment or may be attached by screws (not shown). It will be appreciated by those skilled in the art that different screw holes may be used to adjust the height of the L-shaped member 70 relative to the plurality of compartments so that the housing may be lowered to rest on the handle of the IV pole 36. This adds greater stability to the caddy attachment and places the caddy within easy grasp of a standing user.

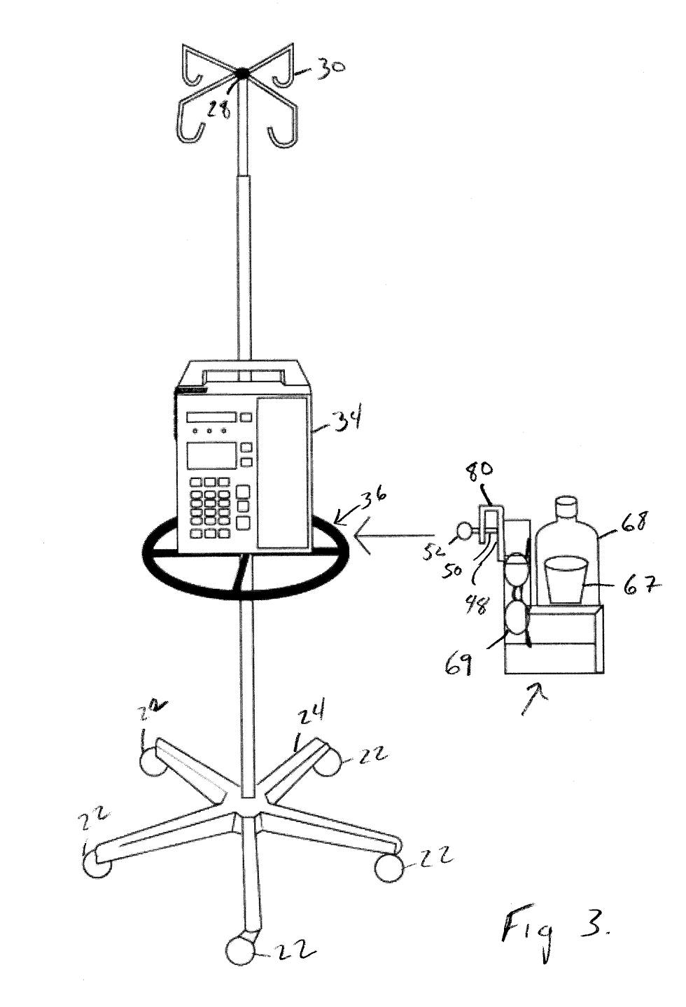

An alternative embodiment of a caddy 42 includes a plurality of compartments configured similarly to FIG. 1 and a clamp 80 (FIG. 3) for attaching the IV pole caddy to an outer rim of the handle clamped to the IV pole. The clamp is of a similar type the configuration of FIG. 1, but is rotated 90 degrees relative to the clamp 43 of FIG. 1 for engaging the bar 38 of the handle clamp 36. It will be appreciated by those skilled in the art that this configuration can be included as part of a universal kit with the reinforced bar such that the plurality of compartments may be in one configuration attached directly to the clamp or in another configuration attached by means of the reinforced bar of FIG. 1.

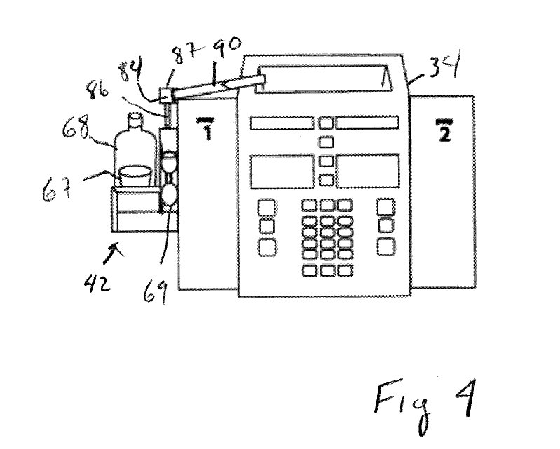

An alternate embodiment of a caddy 42 includes a plurality of compartments similar to FIG. 1 and includes a support extension 84 (FIG. 4) attached by at least one, but preferably two support bars 86 connected by a horizontal cross-member 87 and threadably engaged by strap eyelets (not shown) with a nylon strap 90 for attachment to an auxiliary piece of equipment. The strap may complete a loop either by engagement with opposing ends having hook and loop material or by means of a releasable latch or buckle.

It will further be appreciated by those skilled in the art that the common configuration of the plurality of compartments in FIGS. 1-4 allows the necessary components for each of these configurations to be included in a universal assembly kit in which all desired configurations may be supplied in one product and assembly of different configurations are made by the user.

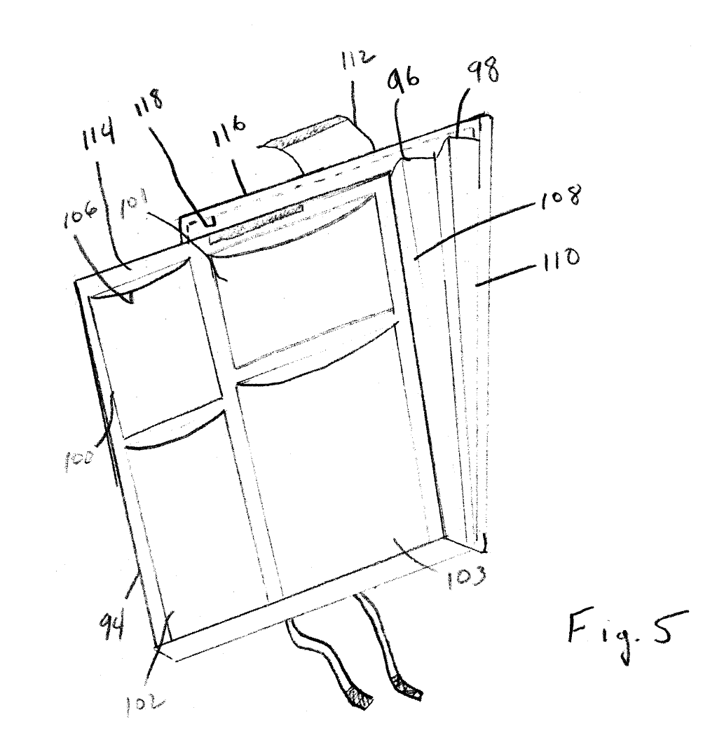

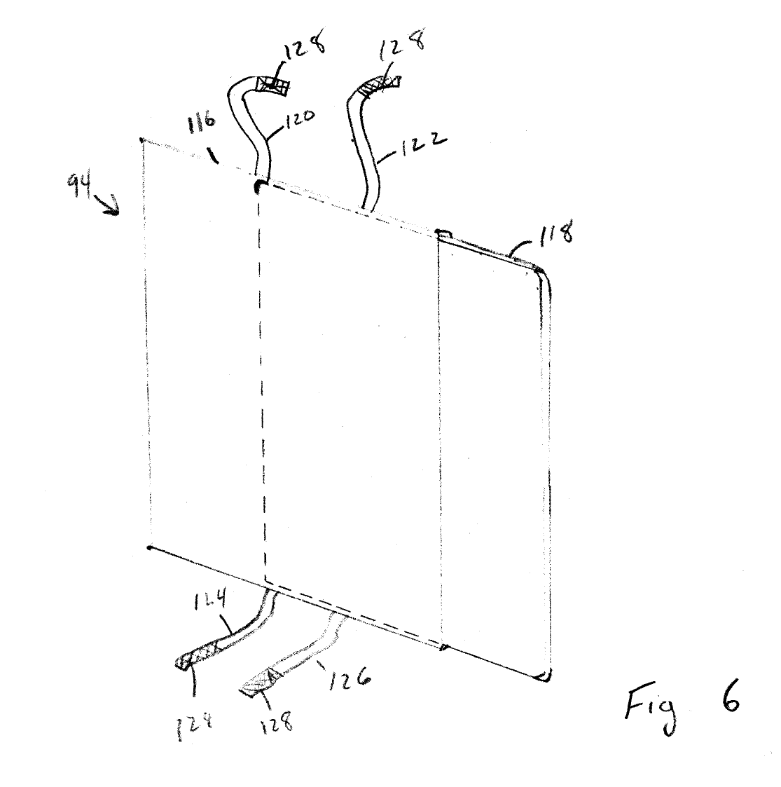

In another alternative embodiment, the caddy is in the form of a nylon canvas bag 94 (FIG. 5) formed with a plurality of book and magazine compartments 96 and 98 as well as expandable net pockets 100-103 formed in a wall of the book/magazine compartment 96 for holding eyewear, a beverage container, a cellular phone or portable music player along with additional compartments for additional personal items. The pockets 100-103 are preferably made from expandable net material to conform and hold various items of differing sizes. The outer mouth is preferably reinforced with a cord material 106 having elastic rubber at the center. As presently shown two book compartments are included and which could also hold a compact notebook computer. The book and magazine compartments 96 and 98 have expandable sidewalls 108 and 110 and a wide fabric strap 112 spanning the front and back walls of the book compartments to hold them together when attached by hook and loop material to the front wall 114 and draw out excess space. The strap may be expanded in width to extend between the sidewalls to function as a cover for the book compartments. The strap is preferably of a elastic material including rubber fibers woven therein to hold front and back walls together. The front wall 114 preferably includes a two-ply fabric with a cardboard or other form holding like material therein. The back wall 116 (FIG. 6) includes a similar configuration with a removable form holding material 118 such as hard board material or plastic. The removable form holding material may be withdrawn and used on the lap of a seated user as a writing surface. The material is removed through a resealable opening in the sidewall that is held in a closed form by hook and loop material.

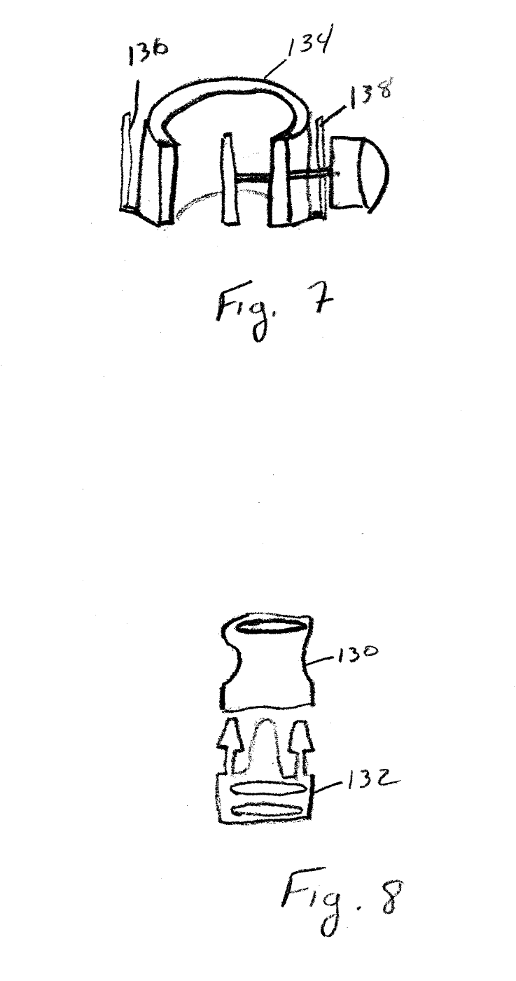

Strap pairs at the top 120 and 122 and bottom 124 and 126 are positioned respectively with each nylon strap in spaced apart relation about the middle portion of the back wall 116. In a preferred embodiment similarly aligned upper and lower straps 120 and 124 and 122 and 126, respectively, are formed from a single nylon strap in which reinforcement stitching of the strap along the back wall is intended to increase the weight holding capability of the straps and caddy. Furthermore the seams of the caddy are stitched in a manner similarly used for backpacks and other like load bearing fabric containers. The straps are fitted with engagements 128 that may be in the form of hook and loop material or more preferably side release buckles 130 and 132 (FIG. 8) such as the type sold by strapworks.com of Eugene, Oreg. under models SRBSA and SRBDA. The buckles 130 and 132 can be used to hold the IV pole caddy onto an IV pole either above the handle clamp by adjusting the straps to hold the pole snuggly while the bottom the caddy rests upon the handle. Alternatively, it can held below the handle clamp by weaving the uppers straps around the spokes and the pole. The lower straps are adjusted for a snug engagement around the pole. Finally, a separate clamp 134 (FIG. 7) can used with strap hooks 136 and 138 in which the upper straps are buckled about the pole and allowed to rest in the strap hooks. The lower straps are adjusted to snuggly hold the IV pole. In his manner the IV caddy will resist movement during movement of the IV pole.

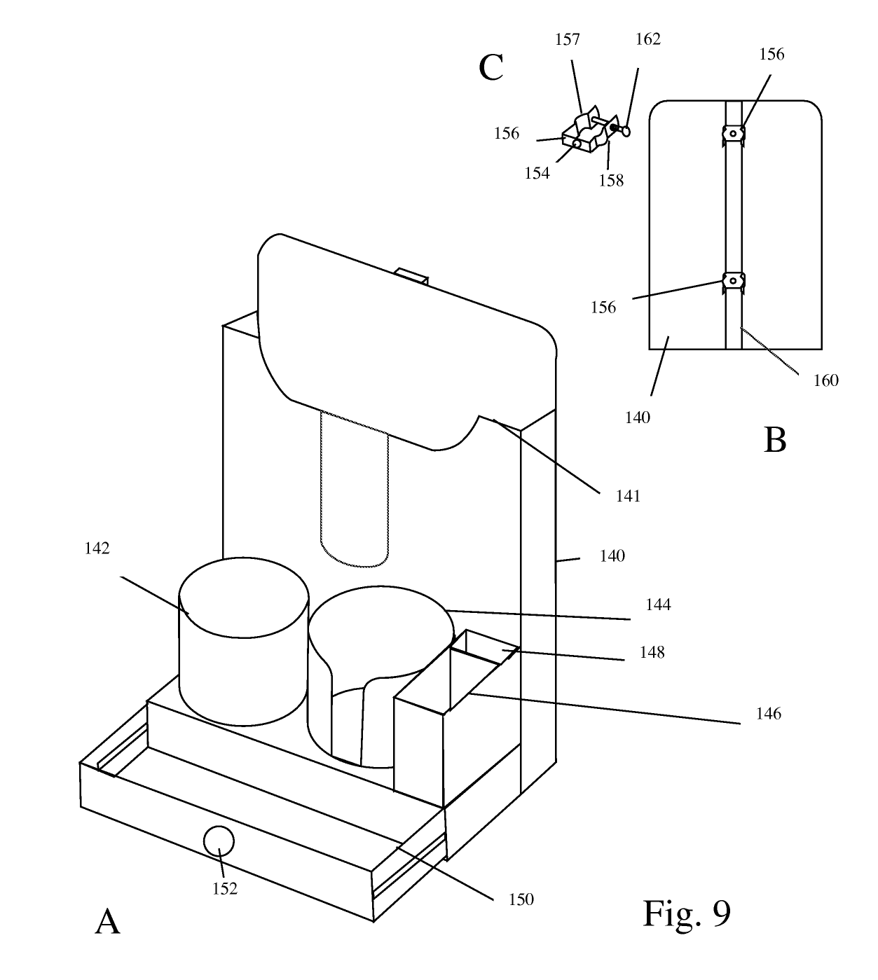

In another embodiment, the IV pole caddy 140 (FIG. 9A) with similar construction as in FIG. 1 includes a compartment housing with compartments for holding a magazine or books 141, beverage containers 142 and 144, a compartment for an electronic device, medicine or the like 146, a container for writing instruments 148, and a drawer 150 for holding miscellaneous items. The drawer islocated in a hollow region at the bottom of the compartment housing. A knob 152 for pulling out the drawer is included and may be optional supplied with a lock and key. The backside of the caddy 140 (FIG. 9B) is attached by screws or rivets 154 to at least two clamps 156. The clamps include opposing arms 157 and 158 that surround the IV pole 160 and are drawn together by a setscrew 162.

It should also be noted that for security concerns all of the embodiments described here in could be made with transparent materials in order to permit security personnel to make efficient inspection of the items contained in the IV pole caddy.

Thus, from the embodiments described an IV pole can be adapted to carry the personal items of a patient and make the time and travel with the pole a more pleasant experience.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. An IV pole assembly comprising:
an IV pole having a telescopic vertically oriented center rod, hooks for supporting an intravenous bag and a support base; and
a caddy having a plurality of compartments having at least one compartment sized and shaped to hold a beverage bottle and at least one compartment sized and shaped to hold an item selected from the group consisting or eyewear, a magazine, a personal electronic communications device and a personal listening device; and
an engagement for holding said caddy at a generally fixed position along the vertical length of the pole;
wherein attaching said caddy to said pole results in a storage area for holding a patients personal items that moves with the IV pole.

2. The apparatus of claim 1 wherein said base includes a bed with an IV pole post.

3. The apparatus of claim wherein said base includes a wheel chair with an IV pole post.

4. The apparatus of claim wherein said base includes a stand supported on a surface by a plurality of castor wheels and a vertical pole for telescopically receiving said IV pole.

5. The apparatus of claim 1 including a bar extending between said engagement and said caddy to thereby position caddy in spaced apart relation away from said engagement and said IV pole.

6. The apparatus of claim 5 wherein said caddy is space apart from said pole in a horizontal direction.

7. The apparatus of claim 6 wherein said engagement is a clamp.

8. The apparatus of claim 7 wherein said bar is made from reinforced metal.

9. The apparatus of claim 1 wherein said caddy is made from materials selected from the group consisting of folded sheet metal and injection molded plastic.

10. The apparatus of claim 1 wherein said caddy is transparent.

11. The apparatus of claim 1 wherein said IV pole includes a handle clamp having a handled formed from a bar lying in a horizontal plane about said IV pole and said engagement includes a clamp aligned to engage against said bar and connected to said caddy.

12. The apparatus of claim 1 wherein said IV pole includes auxiliary equipment coupled thereto and said engagement includes means for engaging said auxiliary equipment to thereby hold said caddy to IV pole.

13. The apparatus of claim 12 wherein said engaging means includes an L-bar extending from said caddy and engaging an upper and side surface of said auxiliary equipment.

14. The apparatus of claim 13 wherein said L-bar includes holding means selected from the group consisting of bonding tape and hook and loop material.

15. The apparatus of claim 12 wherein said engagement means includes a strap and buckle to buckle together said strap at free ends to hang said strap from said auxiliary equipment and strap supports anchored to said caddy from suspending said caddy from said auxiliary equipment.

16. The apparatus of claim 1 wherein said compartments are formed from fabric material and wherein said magazine compartment includes at least one wall having a form holding removeable board wherein said removeable board when removed is a writing surface.

17. The apparatus of claim 16 wherein at least one of said compartments is a pocket of expandable net fabric sewn to a canvas wall of said caddy.

18. The apparatus of claim 17 wherein said canvas wall includes form holding material contained therein.
